(19) United States
(12) Patent Application Publication
(10) Pub. No.: US 2007/0075981 A1
(43) Pub. Date: Apr. 5, 2007

(54) DISPLAY APPARATUS ENABLING TO DISPLAY AND CONTROL A ROUNDISH-SHAPED OSD MENU AND TOUCH-BASED DISPLAY AND CONTROL METHOD THEREFOR

(75) Inventors: Kuan-Hong Hsieh, Shenzhen (CN); Han-Che Wang, Shenzhen (CN); Xiao-Guang Li, Shenzhen (CN); Wen-Chuan Lian, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,373

(22) Filed: Aug. 2, 2006

(30) Foreign Application Priority Data
Sep. 23, 2005 (CN) 200510037476.3

(51) Int. Cl. G09G 5/00

(52) U.S. Cl. 345/173

(57) ABSTRACT

A touch-based method enabling a display apparatus to display and control a roundish-shaped on-screen display (OSD) menu is provided. The touch-based method includes the steps of: providing a display apparatus including a screen and a frame connecting to the screen, the screen including a first menu region and a second menu region, and the frame including a touch strip; generating sensing signals in response to operational inputs on the touch strip, each sensing signal being assigned to a coordinate for identification; timing a duration of the sensing signals; determining a speed of the operational inputs according to the duration and a direction of the operational inputs according to the coordinates assigned to the sensing signals; and rotating menu options displayed in an associated menu region corresponding to the speed in the direction. A related touch-based display apparatus is also provided.

### TECHNICAL FIELD

The present invention relates to a display apparatus and display method therefor, and particularly to a display apparatus enabling to display and control a roundish-shaped on-screen display (OSD) menu and a related touch-based method for the display apparatus.

### GENERAL BACKGROUND

Generally, a display apparatus is a device that is used to visually output graphical data on a screen. The display apparatus has become widely and increasingly used in electronic devices. A first conventional display apparatus includes a screen to display the graphical data (e.g., an image) thereon, and a frame to support the screen. The frame is further disposed a plurality of mechanical function buttons thereon to input selections and actuate any desired function. The more functions the display apparatus has, the more mechanical function buttons the frame is disposed thereon. Therefore, the frame should be designed larger than needed to hold the mechanical function buttons. As a result, a volume of the display apparatus as a whole becomes larger, and an overall appearance of the whole display apparatus looks bulky and untidy.

A second conventional display apparatus adopts a touch screen instead of mechanical buttons for input selections. The touch screen uses a graphical user interface (GUI) to display on the display screen thereof buttons, allowing to touch by finger or the like for input selections. However, by directly touching the display screen, the touch screen thereupon is easily scratched or damaged.

Therefore, there is a need for an improved display apparatus and touch-based method therefore that can overcome the above-mentioned problems.

### SUMMARY

A touch-based display apparatus is provided. The display apparatus is capable of displaying and controlling a roundish-shaped OSD menu. The display apparatus includes a screen and a frame. The screen has a first menu region and a second menu region. The first menu region displays a plurality of OSD function categories, and the second menu region displays a plurality of subcategories of a selected OSD function category. Furthermore, the menus are arranged in a roundish-shaped form. The frame connects to the screen and has a touch strip thereof. The touch strip generates sensing signals in response to operation inputs thereon, and each sensing signal is assigned to a coordinate for identification.

The display apparatus further includes a timer and a processing unit. The timer records a duration of continuously receiving the sensing signals. The processing unit is programmed to determine a speed of the operational inputs according the duration and a direction of the operational inputs according to the coordinates assigned to the sensing signals, thereby rotating the OSD function categories displayed in the first menu region in the direction if the duration is less than a predetermined value, or rotating the subcategories displayed in the second menu region in the direction if the duration is equal to or greater than the predetermined value.

A touch-based method enabling a display apparatus to display and control a roundish-shaped OSD menu is also provided. The method includes the steps of: (a) providing a display apparatus having a screen and a frame connecting to the screen, the screen having a first menu region and a second menu region, and the frame including a touch strip; (b) generating sensing signals in response to operational inputs on the touch strip, each sensing signal being assigned to a coordinate for identification; (c) timing a duration of continuously receiving the sensing signals; (d) determining a speed of the operational inputs according to the duration and a direction of the operational inputs according to the coordinates assigned to the sensing signals; and (e) rotating menu options displayed in an associated menu region corresponding to the speed in the direction.

Other advantages and novel features will be drawn from the following detailed description with reference to the attached drawings, in which:

### BRIEF DESCRIPTION OF THE DRAWINGS

FIG. 1 is an exemplary schematic diagram of a touch-based display apparatus enabling to display and control a roundish-shaped on-screen display (OSD) menu in accordance with a preferred embodiment of the present invention, the display apparatus including a screen and a frame, the frame including a touch strip thereof;

FIG. 2 is a schematic block diagram of a hardware infrastructure of the display apparatus of FIG. 1;

FIG. 3 is an exemplary block diagram representing a hardware infrastructure of a sensing signal processing circuit for a touch sensitive unit of FIG. 2 with the signal processing circuit connecting to a processing unit;

FIG. 4 represents a display state of the display apparatus of FIG. 1 with the roundish-shaped OSD menu thereon;

FIG. 5 is a flowchart of a preferred touch-based method for enabling the display apparatus of FIG. 1 to display and control the roundish-shaped OSD menu in accordance with a preferred embodiment of the present invention; and

FIG. 6 is a flowchart further detailing steps involving in displaying and controlling the roundish-shaped OSD menu utilizing the method of FIG. 5.

### DETAILED DESCRIPTION OF THE EMBODIMENTS

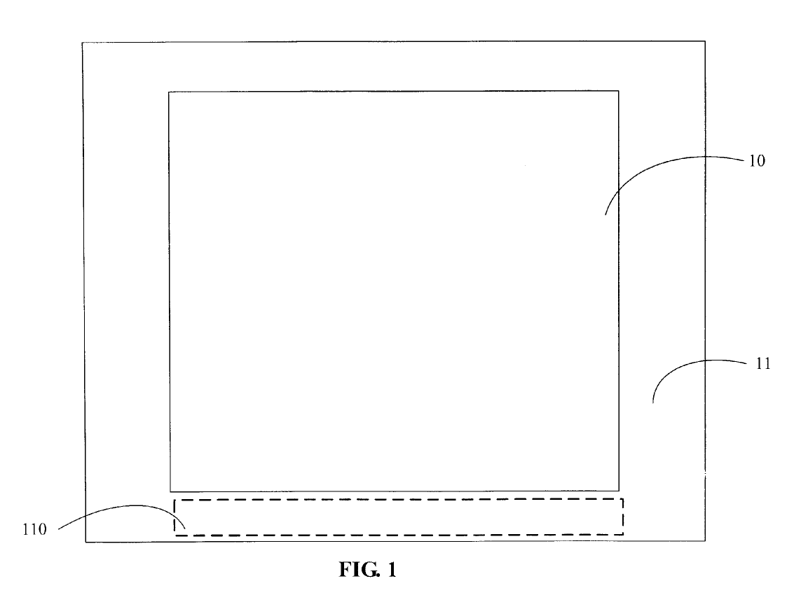

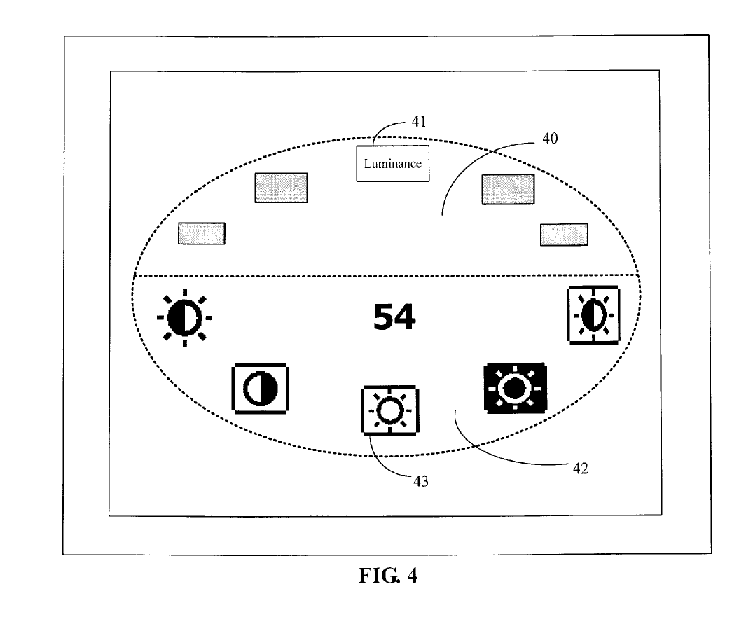

Referring to FIG. 1 and FIG. 4, a touch-based display apparatus enabling to display and control a roundish-shaped on-screen display (OSD) menu in accordance with a preferred embodiment of the present invention is shown. The display apparatus includes a screen 10 and a frame 11. The screen 10 has a first menu region and a second menu region (symbolically indicated by 40 and 42 respectively) each displaying a menu therein. The menus each contain a quantity of menu options and a portion of the quantity of menu options may be hidden due to a limited space of the screen 10. Furthermore, the menus are arranged in a roundish-shaped form such as, for example, an ellipse, a circle, and so on. For simplicity, in this embodiment, the elliptical-type OSD menu is provided by way of example.

The first menu region 40 is designated to display a top portion of the elliptical-type OSD menu (separated as shown with the dotted lines), whereas the second menu region 42 is designated to display a bottom portion of the elliptical-type OSD menu, namely a sub-menu of a selected menu option in the first menu region 40 simultaneously. Furthermore, the first menu region 40 and the second menu region 42 respectively have a first selection area 41 and a second selection area 43 for indicating a desired menu option therein. However, the designated relationship between the elliptical-type OSD menu and the menu regions should not be construed as limiting the invention.

In other words, the first menu region 40 displays a plurality of OSD function categories, for example, volume, color, luminance, signal source, position, and so on, and each OSD function category may include a number of subcategories. Simultaneously, the second menu region 42 displays the subcategories of a selected OSD function category (e.g., a luminance OSD function menu option) displayed in the first selection area 41. In other words, the second menu region 42 displays the luminance subcategory, contrast subcategory, brightness subcategory, backlight subcategory, effect subcategory, and so on.

In addition, the size of each OSD function category in the first menu region 40 may vary according to the display position thereof on the screen 10. That is, the OSD function category may be displayed in a smaller size when its position is closer to the second menu region 42 (as shown with the dotted lines) of the screen 10. In contrast, the OSD function category may be displayed in a larger size when its position is further away from the second menu region 42 (as shown with the dotted lines) of the screen 10.

To operate the elliptical-type OSD menu, the frame 11 provides a touch strip 110 thereon being operable by contact to perform a selected function associated with the menu options displayed in the menu regions. Furthermore, a length of the touch strip 110 is preferably designed to correspond to a length of an adjacent menu region.

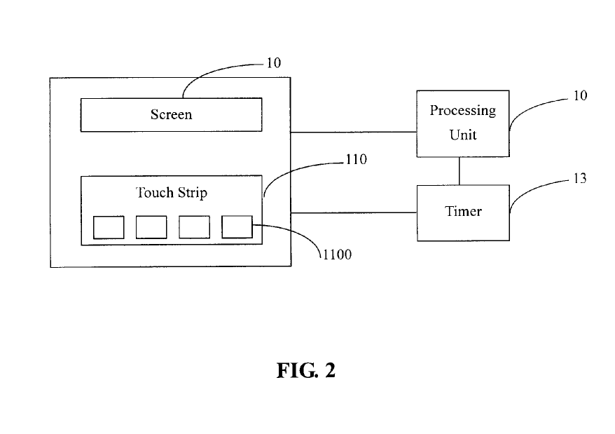

Referring to FIG. 2, the touch strip 110 has a plurality of touch sensitive units 1100 beneath thereof for generating sensing signals to perform the functions associated with the menu options displayed in the menu regions, in response to operational inputs on the touch strip 110. Moreover, each touch sensitive unit 1100 includes a sensing signal processing circuit 112 (described in more detail below) for generating the sensing signals. Each touch sensitive unit 1100 is further assigned a coordinate for identification.

The display apparatus further includes a processing unit 12 and a timer 13. The timer 13 records a duration of continuously receiving the sensing signals from the touch strip 110. The processing unit 12 determines a speed of the operational input according to the duration of the timer 13 and a direction of the operational input according to coordinates assigned to the sensing signals, and moves menu options of an associated menu corresponding to the speed and the direction.

For example, if the duration of the timer 13 is less than a predetermined value, the processing unit 12 rotates the OSD function categories displayed in the first menu region in the direction; furthermore, if further not receiving any sensing signal from the touch strip 110 in a predetermined time span, the processing unit 12 expands the subcategories of the selected OSD function category displayed in the first selection area 41.

Alternatively, if the duration of the timer 13 is equal to or greater than the predetermined value, the processing unit 12 rotates the subcategories displayed in the second menu region in the direction; furthermore, if further not receiving any sensing signal from the touch strip 110 in the predetermined time span, the processing unit 12 performs the function associated with the selected subcategory displayed in the second selection area 43.

For example, the processing unit 12 displays a parameter value (e.g., 54) of the selected subcategory (e.g., brightness) in a particular location such as, for example, above the second selection area 43, and adjusts the parameter value of the selected subcategory according to any further sensing signals received from the touch strip 110. That is, the processing unit 12 increases the parameter value of the selected subcategory if the sensing signals are from a particular location of the touch strip 110 such as, for example, the right side of the touch strip 110; alternatively, the processing unit 12 decreases the parameter value of the selected subcategory if the sensing signals are from another particular location of the touch strip 110 such as, for example, the left side of the touch strip 110.

Accordingly, because the touch strip 110 is used instead of function buttons for selecting and performing functions, the frame 11 can retain its neatness, regardless of how many functions the display apparatus has. Furthermore, since the surface area of the touch strip 110 can be designed in a smaller size, the frame 11 of the display apparatus thereupon can be designed in a narrower size, whereas the screen 10 thereof can be designed in a larger size, thereby the display apparatus may not only obtain a neater appearance but may also posses a larger screen for display. Moreover, due to the touch strip 110 and dynamic roundish-shaped OSD menu of the display apparatus, the user can easily select a desired menu option to perform the function associated therewith.

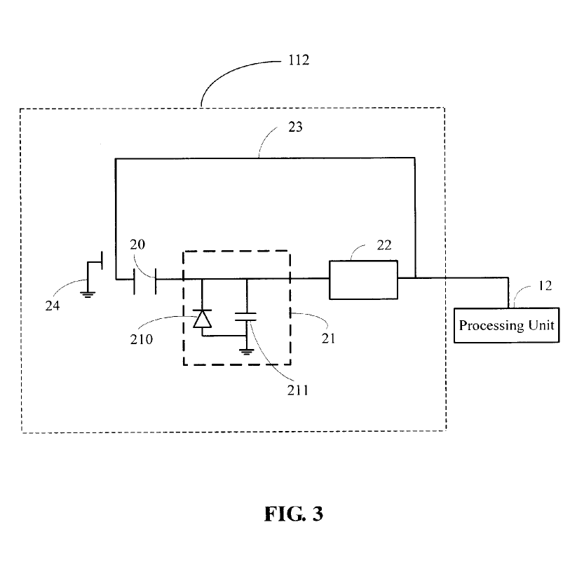

FIG. 3 is a block diagram of the sensing signal processing circuit 112 for the touch sensitive unit 1100 of FIG. 2 according to one embodiment of the present invention, wherein the signal processing circuit 112 is in communication with the processing unit 12. The sensing signal processing circuit 112 has an antenna 20, a clamping circuit 21, a detector 22, a feedback line 23, and a grounding line 24. The antenna 20 is connected to the clamping circuit 21. The clamping circuit 21 is electrically coupled to an input end of the detector 22, which itself is electrically coupled to an output end of the detector 22 is respectively electrically coupled to the processing unit 12 and one end of the feedback line 23. The feedback line 23 forms a positive feedback circuit with the antenna 21. The grounding line 24, which takes a form of a space between two adjacent touch sensitive units 1100, is for spacing the touch sensitive units 1100 therebetween.

It is known that the human body is electrically charged with noise and static signals. Therefore, when a user contacts the touch strip 110, the noise and static signals of the user with a desired signal may be received by the antenna 20. The antenna 20 transmits the received noise and static signals to the clamping circuit 21. However, the static electrical signals may cause interference to normal operation of the detector 22, and may even fry the detector 22. In addition, a strong noise may adversely influence a resulting sensing signal for the processing unit 12; that is, the sensitivity of the touch sensitive unit 1100 may be diminished, and the quality of the resulting sensing signal may be negatively impacted. Accordingly, the clamping circuit 21 is adapted for eliminating the static signals and for reducing the noise, thus improving the sensitivity accuracy of the touch sensitive unit 1100.

The clamping circuit 21 in one embodiment of the present invention includes a diode 210, and a capacitor 211. The cathode of the diode 210 is electrically coupled to the antenna 20, while the anode is electrically coupled to ground. Upon receiving the noise and static signals with a desired signal, the diode 210 filters out the static signals to ground so as to avoid frying the detector 22, and reducing the noise influencing to the capacitor 211. The capacitor 211 further leaks a portion of the reduced noise to ground. Thus the reduced noise is further weakened, thereby obtaining a more accurate sensitivity.

The detector 22 has a high input impedance, so as to easily detect the desired signal with the reduced and weakened noise received from the input end of the detector 22. The detector 22 then converts the desired signal with the reduced and weakened noise into digital signals, namely the sensing signals, and transmits the digital signals through the output end of the detector 22 to the processing unit 12 to perform corresponding controls. Furthermore, because the feedback line 23 forms a positive feedback circuit with the antenna 20, the noise generated as the user touches the edge of the touch sensitive unit 1100 is filtered, thereby further improving the sensitivity accuracy of the touch sensitive unit 1100.

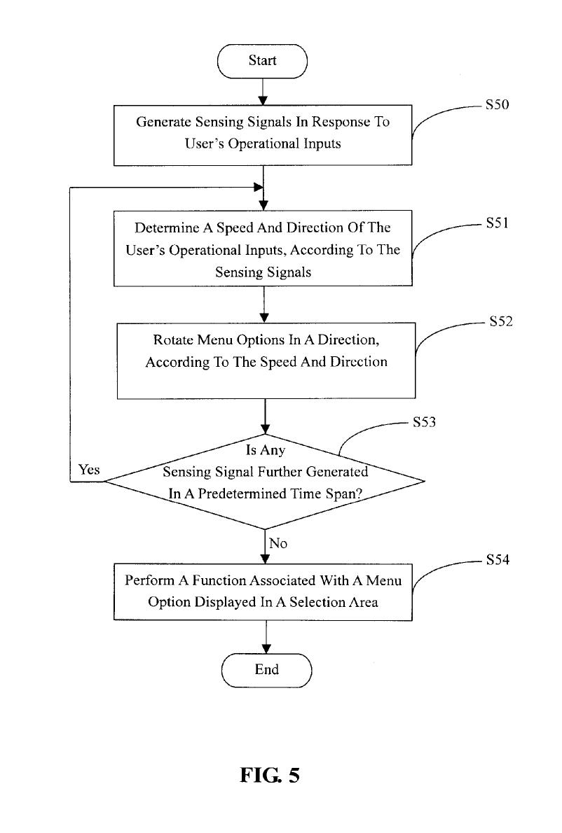

FIG. 5 is a flowchart of a preferred touch-based method for enabling the display apparatus of FIG. 1 to display and control the roundish-shaped OSD menu in accordance with a preferred embodiment of the present invention. In step S50, the touch strip 110 generates sensing signals in response to the operational input thereon, and transmits the sensing signals to the processing unit 12 and the timer 13 connected thereto.

In step S51, the processing unit 12 determines the speed and the direction of the operational input according to the sensing signals. That is, the processing unit 12 determines the speed of the operational input according to the duration of continuously receiving the sensing signals, and determines the direction of the operational input according to the coordinates assigned to the sensing signals.

In step S52, the processing unit 12 rotates menu options displayed in an associated menu region corresponding to the speed and the direction. That is, if the duration is less than a predetermined value, the processing unit 12 rotates the OSD function categories displayed in the first menu region 40 in the direction; alternatively, if the duration is equal to or greater than the predetermined value, the processing unit 12 rotates the subcategories displayed in the second menu region 42 in the direction.

In step S53, the processing unit 12 determines whether it further receives any sensing signal from the touch strip 110 in a predetermined time span. If not receiving any sensing signal in the predetermined time span, the processing unit 12 performs a function associated with a menu option displayed in the selection area. That is, after rotating the OSD function categories, the processing unit 12 expands the sub-menu of the selected OSD function category displayed in the first selection area 41 if further not receiving any sensing signal in the predetermined time span; alternatively, after rotating the subcategories, the processing unit 12 performs the function of the subcategory displayed in the second selection area 43 if further not receiving any sensing signal in the predetermined time span.

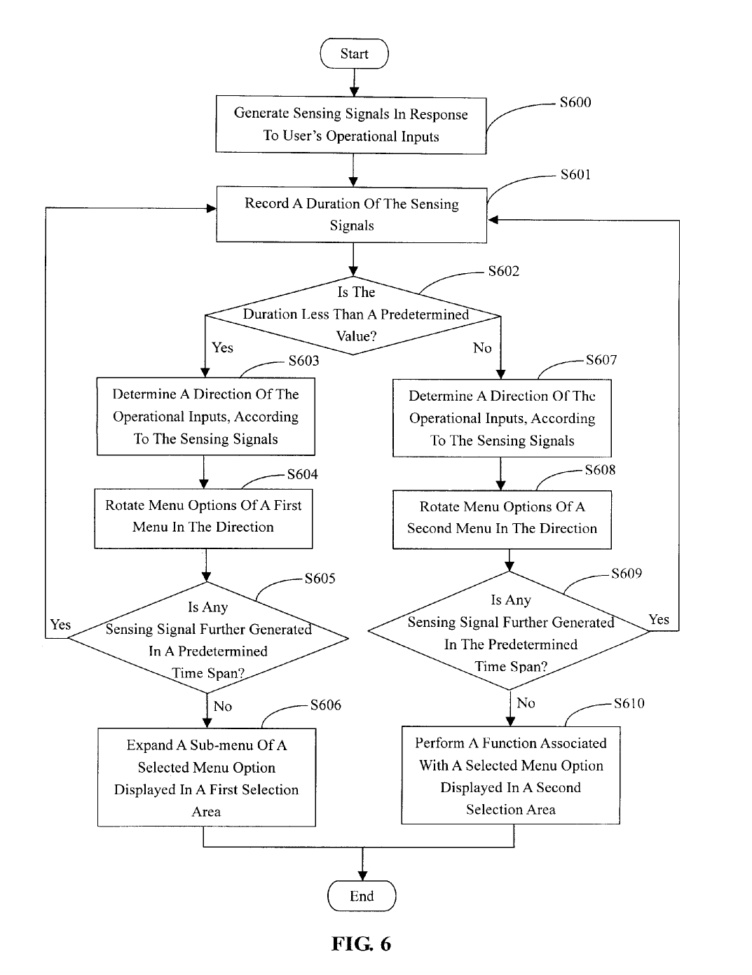

FIG. 6 is a flowchart further detailing steps involving in displaying and controlling the roundish-shaped OSD menu utilizing the method of FIG. 5. In step S600, the touch strip 110 generates sensing signals in response to the operational input thereon, and transmits the sensing signals to the processing unit 12 and the timer 13 connected thereto. In step S601, the timer 13 records the duration of continuously receiving the sensing signals. In step S602, the processing unit 12 determines whether the duration of the timer 13 is less than the predetermined value.

If the duration is less than the predetermined value, in step S603, the processing unit 12 determines the direction of the operational input according to the coordinates assigned to the sensing signals. In step S604, the processing unit 12 rotates the OSD function categories displayed in the first menu region 40 in the direction. In step S605, the processing unit 12 determines whether it further receives any sensing signal in the predetermined time span. If not, the procedure goes to step S601 described above. If received, in step S606, the processing unit 12 expands the subcategories of the selected OSD function category displayed in the first selection area 41.

If the duration is equal to or greater than the predetermined value, in step S607, the processing unit 12 determines the direction of the operational input according to the coordinates assigned to the sensing signals. In step S608, the processing unit 12 rotates the subcategories displayed in the second menu region 42 in the determined direction. In step S609, the processing unit 12 determines whether it further receives any sensing signal in the predetermined time span. If not, the procedure goes to step S601 described above. If received, in step S610, the processing unit 12 performs the function of the selected subcategory displayed in the second selection area 43.

Although the present invention has been specifically described on the basis of the preferred embodiment and preferred method thereof, the invention is not to be construed as being limited thereto. Various changes or modifications may be made to the embodiment and method without departing from the scope and spirit of the invention.

What is claimed is:

1. A display apparatus enabling to display and control a roundish-shaped on-screen display (OSD) menu, the display apparatus comprising:
a screen including a first menu region and a second menu region, wherein the first menu region displays a plurality of OSD function categories, and the second menu region displays a plurality of subcategories of a selected OSD function category, menu options and sub-menu options are distributed in a roundish-shaped form; and
a frame connecting to the screen and including a touch strip, wherein the touch strip generates sensing signals in response to operational inputs thereon, each sensing signal is assigned a coordinate for identification;
a timer for recording a duration of continuously receiving the sensing signals; and
a processing unit being programmed for determining a speed of the operational inputs according to the duration and a direction of the operational inputs according to the coordinates assigned to the sensing signals, thereby rotating the OSD function categories displayed in the first menu region in the direction if the duration is less than a predetermined value, or rotating the subcategories displayed in the second menu region in the direction if the duration is equal to or greater than the predetermined value.

2. The apparatus according to claim 1 wherein the processing unit further expands the subcategories of the selected OSD function category displayed in a first selection area of the first menu region if not further receiving any sensing signal in a predetermined time span.

3. The apparatus according to claim 2, wherein the processing unit further performs a function associated with a selected subcategory displayed in a second selection area of the second menu region if further not receiving any sensing signal in the predetermined time span.

4. A display apparatus enabling to display and control a roundish-shaped on-screen display (OSD) menu, the display apparatus comprising:
a screen including a first menu region and a second menu region each displaying a menu therein, wherein the menu in the second menu region is a sub-menu of a menu option of the menu in the first menu region, and menu options and sub-menu options are distributed in a roundish-shaped form; and
a frame connecting to the screen and including a touch strip, wherein the touch strip generates sensing signals in response to operational inputs thereon, each sensing signal is assigned a coordinate for identification;
a timer for recording a duration of continuously receiving the sensing signals; and
a processing unit being programmed for determining a speed of the operational inputs according to the duration and a direction of the operational inputs according to the coordinates assigned to the sensing signals, thereby rotating menu options of an associated menu corresponding to the speed and the direction.

5. The apparatus according to claim 4, wherein the processing unit rotates the menu options displayed in the first menu region in the direction if the duration is less than a predetermined value.

6. The apparatus according to claim 5, wherein the processing unit further expands the sub-menu of a selected menu option displayed in a first selection area of the first menu region if further not receiving any sensing signal in a predetermined time span.

7. The apparatus according to claim 4, wherein the processing unit rotates the menu options displayed in the second menu region in the direction if the duration is equal to or greater than the predetermined value.

8. The apparatus according to claim 7, wherein the processing unit further performs a function associated with a selected menu option displayed in a second selection area of the second menu region if further not receiving any sensing signal in the predetermined time span.

9. A touch-based method enabling a display apparatus to display and control a roundish-shaped on-screen display (OSD) menu, the method comprising the steps of:
providing a display apparatus comprising a screen and a frame connecting to the screen, the screen including a first menu region and a second menu region, and the frame including a touch strip;
generating sensing signals in response to operational inputs on the touch strip, each sensing signal being assigned to a coordinate for identification;
recording a duration of continuously receiving the sensing signals;
determining a speed of the operational inputs according to the duration and a direction of the operational inputs according to the coordinates assigned to the sensing signals; and
rotating menu options displayed in an associated menu region corresponding to the speed and the direction.

10. The touch-based method according to claim 9, wherein the rotating step further comprises the steps of:
rotating the menu options displayed in the first menu region in the direction if the duration is less than a predetermined value; and
expanding a sub-menu of a selected menu option displayed in a first selection area of the first menu region if further not receiving any sensing signal in a predetermined time span.

11. The touch-based method according to claim 9, wherein the rotating step further comprises the steps of:
rotating the menu options displayed in the second menu region in the direction if the duration is equal to or greater than the predetermined value; and
performing a function associated with a selected menu option displayed in a second selection area of the second menu region if further not receiving any sensing signal in the predetermined time span.
